(19) United States
(12) Patent Application Publication
(10) Pub. No.: US 2003/0185001 A1
(43) Pub. Date: Oct. 2, 2003

(54) Fluorescent light fixture and method of manufacturing same

(75) Inventors: Wang Liang Chou, Taichung City (CN); Bentley Chelf, Laguna Nigel, CA (US)

Correspondence Address: HAYNES AND BOONE, LLP, 901 MAIN STREET, SUITE 3100, DALLAS, TX, 75202, US

(73) Assignee: General Innovations, LLC, Laguna Nigel, CA

(21) Appl. No.: 10/112,343

(22) Filed: Mar. 28, 2002

(51) Int. Cl. F21V 23/02; F21S 8/00

(52) U.S. Cl. 362/221; 362/217; 362/225; 362/362

(57) ABSTRACT

A lighting fixture in which a housing defines a center channel, and at least one side channel extending to a side of the center channel and parallel to the center channel. A ballast is disposed in the center channel, and two sockets are connected to the respective ends of each side channel to form an assembly the height of which is less than the combined height of the socket and the ballast. It is emphasized that this abstract is provided to comply with the rules requiring an abstract that will allow a searcher or other reader to quickly ascertain the subject matter of the technical disclosure; and is submitted with the understanding that it will not be used to interpret or limit the scope or meaning of the claims under 37CFR 1.72

### BACKGROUND

This invention relates, in general to a fluorescent light fixture that is compact in size, and a method of manufacturing same.

Most conventional fluorescent light fixtures include sockets enclosed within a housing or frame, along with an upper channel that houses a ballast, and two end caps. The ballast is usually placed in a position above the sockets thus increasing the height of the fixture, resulting in a relatively bulky fixture that takes up considerable room in use and in shipping.

Accordingly, what is needed is a fluorescent light fixture that is more compact in size.

### BRIEF DESCRIPTION OF THE DRAWINGS

FIG. 1 is an exploded isometric view of a fluorescent light fixture according to an embodiment of the present invention.

FIG. 2 is an enlarged isometric view of the assembled light fixture of FIG. 1.

FIG. 3 is a sectional view taken along the line 3-3 of FIG. 2.

### DETAILED DESCRIPTION

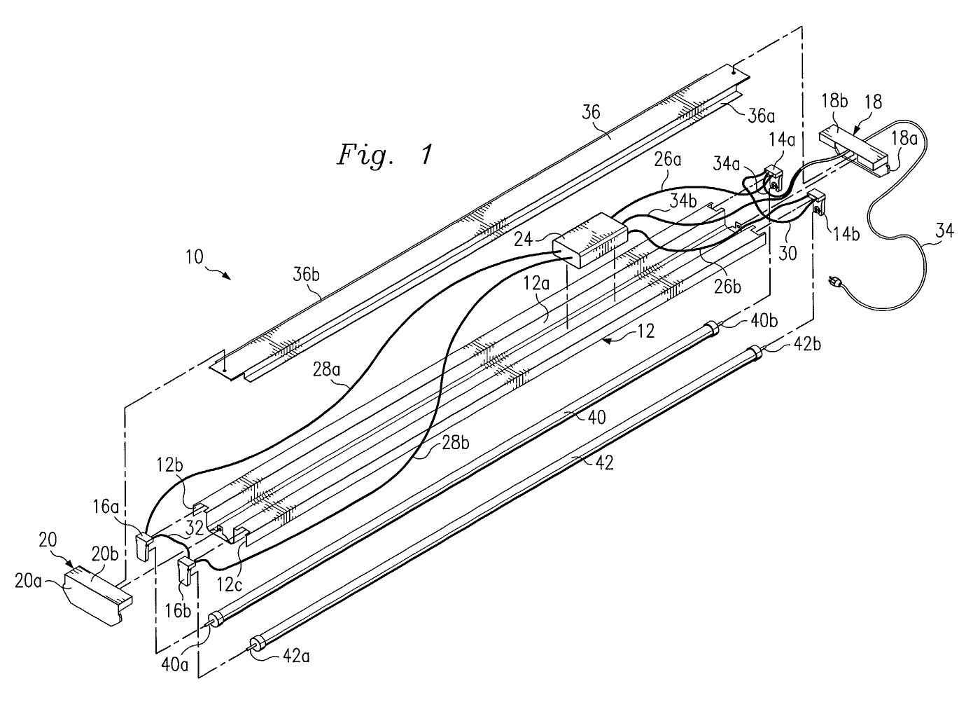

Referring to FIGS. 1-3 of the drawings, the reference numeral 10 refers, in general, to a fluorescent light fixture formed by a housing 12 that is bent in several planes to form a center channel 12a and two spaced, parallel side channels 12b and 12c extending to either side of the center channel and parallel to the latter channel. The channel 12a opens to the upper portion of the housing as viewed in FIG. 1, and the channels 12b and 12c are inverted relative to the channel 12 and open to the lower portion of the housing. The channels 12a, 12b, and 12c are all of approximately the same height and they all extend for the entire length of the housing 12.

A pair of sockets 14a and 14b are disposed at one end of the housing 12 at the corresponding ends of the channels 12b and 12c, respectively and in registry with the channels. Similarly, a pair of sockets 16a and 16b are disposed at the other end of the housing 12 at the other corresponding ends of the channels 12b and 12c, respectively, and in registry with the channels. The sockets 14a, 14b, 16a, and 16b are affixed to the housing 12 in any known manner and are designed to receive two conventional elongated fluorescent bulbs, as will be described.

Two L-shaped end caps 18 and 20 extend over the respective ends of the housing 12. The end cap 18 has one leg 18a that extends over the sockets 14a and 14b, and another leg 18b that extends over the upper surface of the housing 12; while the end cap 20 has one leg 20a that extends over the sockets 16a and 16b, and another leg 20b that extends over the upper surface of the housing 12. The end caps 18 and 20 are affixed to the housing 12 in any known manner.

A ballast 24 is disposed in the channel 12a of the housing 12 and can be secured to the housing in any known manner. The ballast 24 functions in a conventional manner to receive a source of AC power and provide a starting voltage to the fixture, in a conventional manner.

A pair of electrical conductors 26a and 26b connect the sockets 14a and 14b, respectively, to the ballast 24; and a pair of electrical conductors 28a and 28b connect the ballast 24 to the sockets 16a and 16b, respectively. An electrical conductor 30 connects the sockets 14a and 14b, and an electrical conductor 32 connects the sockets 16a and 16b.

A cable 34 extends through an opening in the end cap 20 and consists of two conductors 34a and 34b which are separated inside the end cap and are connected to the socket 14a and to the ballast 24, respectively. The conductors 34a and 34b of that portion of the cable extending outside the end cap 20 are covered with an insulative sheath and the end of the cable extending outside the end cap is adapted to be connected to a source of AC power, in a conventional manner.

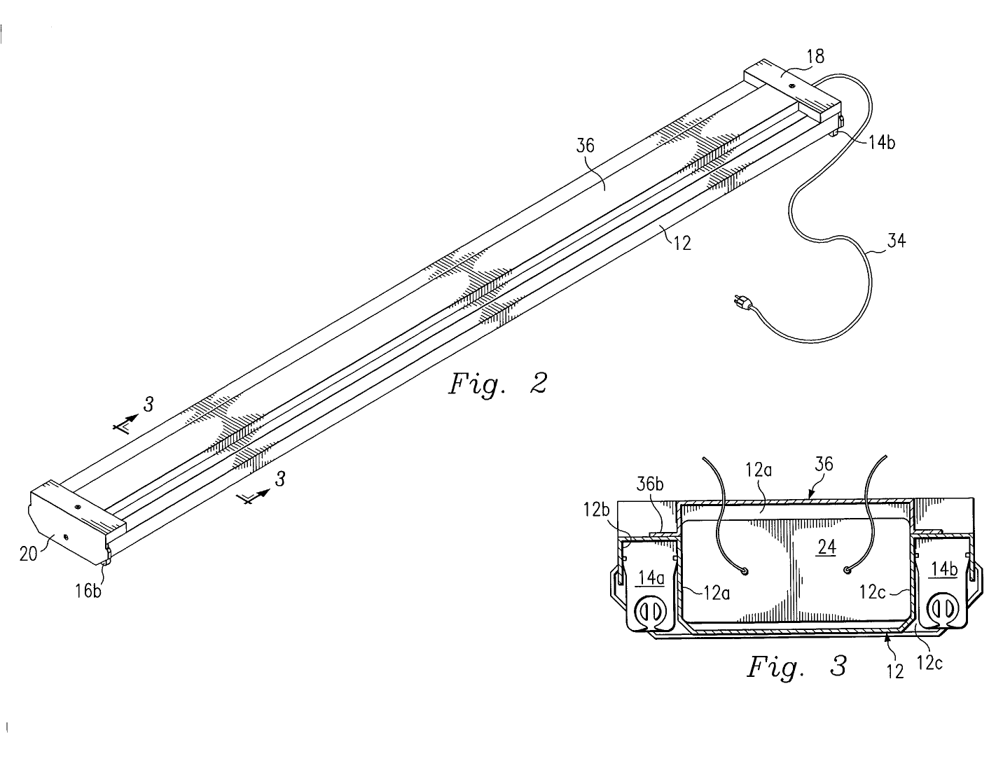

The ballast 24 and conductors 26a, 26b, 28a, 28b, 30, 32, 34a and 34b are all disposed in the channel 12a of the housing 12, with the upper portion of the ballast extending slightly upwardly from the channel, as shown in FIG. 3. A cover plate 36 extends over the channel 12a and has a pair of flanges 36a and 36b extending from the respective side margins of the plate. The flanges 36a and 36b extend over corresponding upper surfaces of the housing 12 and are fastened thereto in a conventional manner. This elevates the cover plate 36 from the upper portion of the housing 12 a sufficient distance to accommodate, or completely cover, the ballast 24.

The respective end portions of the cover plate 36 extend outwardly from the flanges 36a and 36b and below the legs 18b and 20b of the end caps 18 and 20, respectively. These end portions of the cover plate 36 can be fastened to the end caps 18 and 20 respectively, and/or to the housing 12 in any conventional manner.

Two conventional, elongated, fluorescent bulbs 40 and 42 are provided with the bulb 40 having two pins 40a and 40b extending out from its respective ends and the bulb 42 having two pins 42a and 42b extending out from its respective ends. The bulb 40 is inserted in the channel 12b, and its pins 40a and 40b are inserted in the sockets 14a and 14b; and the bulb 42 is inserted in the channel 12a and its pins 42a and 42b inserted in the sockets 14c and 14b.

Thus, when the cable 34 is connected to a source of AC power it supplies a current to the ballast 24 which, in turn, provides a starting voltage to activate the bulbs 40 and 42. Although not shown in the drawings in the interest of clarity, it is understood that reflectors can be provided alone each side of the housing 12 to reflect the light produced by the bulbs 40 and 42, in a conventional manner.

It is noted that, in the above arrangement, the fixture 10 has a relatively low profile, or height, since the ballast 24 is disposed in the channel 12a in the housing 12 and housed by the channel and the cover plate 36; while the sockets 14a, 14b, 16a, and 16b are disposed at the end of the housing in registry with the corresponding ends of the channels 12b and 12c. Thus the ballast 24 does not extend substantially above the sockets 14a, 14b, 16a and 16b, and the heights of the ballast and each socket are thus not additive, permitting a relatively compact design of the fixture 10, especially from a height standpoint, when compared to other designs.

Variations may be made in the foregoing without departing from the scope of the invention. For example, the number of sockets, and therefore, the number of light bulbs can be varied from the amount shown and described above. For example, one of the side channels 12a or 12b, and its associated sockets, could be eliminated, and only one side channel and bulb employed. Also, the specific design of the sockets 14a, 14b, 16a and 16b can be changed, as long as an electrical connection is established with the bulbs.

Although only a few exemplary embodiments of this invention have been described in detail above, those skilled in the art will readily appreciate that many other modifications are possible in the exemplary embodiments without materially departing from the novel teachings and advantages of this invention. Accordingly, all such modifications are intended to be included within the scope of this invention as defined in the following claims. In the claims, means-plus-function clauses are intended to cover the structures described herein as performing the recited function and not only structural equivalents, but also equivalent structures.

What is claimed is:

1. A lighting fixture comprising a housing defining a center channel, and at least one side channel extending to a side of the center channel and parallel to the main channel, a ballast disposed in the center channel, and two sockets connected to the respective ends of each side channel to form an assembly the height of which is less than the combined height of the socket and the ballast.

2. The fixture of claim 1 wherein each side channel is coplanar with the center channel.

3. The fixture of claim 1 wherein there are two side channels extending to the respective sides of the center channel.

4. The fixture of claim 1 further comprising a bulb extending between, and electrically and mechanically connected to, the sockets associated with each side channel.

5. A lighting fixture comprising a housing defining a center channel, and at least one side channel extending to a side of the center channel and parallel to the main channel, a ballast disposed in the center channel, and means connected to the respective ends of each side channel for receiving a light bulb, the height of the fixture being less than the combined height of the means and the ballast.

6. The fixture of claim 5 wherein each side channel is coplanar with the center channel.

7. The fixture of claim 5 wherein there are two side channels extending to the respective sides of the center channel.

8. A method of manufacturing a lighting fixture comprising bending a piece of sheet metal to define a center channel, and at least one side channel extending to a side of the center channel and parallel to the main channel, disposing a ballast disposed in the center channel, and connecting two sockets connected to the respective ends of each side channel to form an assembly the height of which is less than the combined height of the socket and the ballast.

9. The method of claim 8 wherein each side channel is coplanar with the center channel.

10. The method of claim 8 wherein there are two side channels extending to the respective sides of the center channel.
